(19) United States
(12) Patent Application Publication
(10) Pub. No.: US 2024/0281939 A1
(43) Pub. Date: Aug. 22, 2024

(54) IMAGE PROCESSING APPARATUS FOR APPLYING IMAGE PROCESSING TO PERSPECTIVE PROJECTION IMAGE, IMAGE PROCESSING METHOD AND NON-TRANSITORY COMPUTER-READABLE STORAGE MEDIUM

(71) Applicant: CANON KABUSHIKI KAISHA, Tokyo (JP)

(72) Inventor: MASAAKI KOBAYASHI, Tokyo (JP)

(21) Appl. No.: 18/437,901

(22) Filed: Feb. 9, 2024

(30) Foreign Application Priority Data
Feb. 17, 2023 (JP) 2023-023632

(51) Int. Cl. G06T 5/80; G06T 5/20; G06T 5/50; G06T 5/73

(52) U.S. Cl. CPC G06T 5/80; G06T 5/20; G06T 5/50; G06T 5/73; G06T 2207/20028; G06T 2207/20221

(57) ABSTRACT

An image processing apparatus comprises one or more memories and one or more processors. The one or more processors and the one or more memories are configured to input a non-perspective projection image; transform a respective image in each image region of a plurality image regions in the non-perspective projection image into a respective perspective projection image; and, for each of the respective perspective projection images, after applying image processing to the respective perspective projection image, transform the result of the image processing into a respective non-perspective projection image.

### BACKGROUND

### Technical Field

One disclosed aspect of the embodiments relates to an image processing technique for a non-perspective projection image.

### Description of the Related Art

In recent years, Head Mounted Display (HMD) type XR information processing terminals have begun to become popular. XR is a generic term for Virtual Reality (VR), augmented reality (AR), and Mixed Reality (MR).

In an HMD type XR information processing terminal, not only computer graphics (CG) but also a live shot can be viewed, and a part of a wide-angle image captured using a fisheye lens is cut out following the motion of the head, transformed into a perspective projection image, and displayed. Perspective projection is a projection method in which all points on a three-dimensional object are considered to be radially focused on a single viewpoint. A narrow definition of perspective projection is a projection onto a plane; however, a lens is arranged in front of an HMD display panel, and it is not the case that an image is displayed on a plane. However, since dealing with an image that is radially focused on a single viewpoint is not different therefrom, the projections are collectively referred to as a perspective projection hereinafter. Examples of live-shot wide-angle image contents for XR include a 360-degree image (also referred to as an omnidirectional image or the like) and a stereo 180-degree image. A 360-degree image is created by joining images captured by two or more fisheye cameras. A stereo 180-degree image is obtained by performing stereo image capturing by aligning fisheye lenses. Recording at the time of image capture is often performed in a form of a fisheye image, but as content for distribution for HMD, a fisheye image to which mesh information for facilitating transformation into a perspective projection image is attached, or a fisheye image transformed into an equirectangular image is used. The mesh information is information of coordinates of intersection points when the fisheye image is divided into triangles and coordinates projecting the intersection points onto a hemisphere. The projected coordinates in the mesh information are obtained after having removed distortion of the lens. At the time of display in the HMD, in relation to pixels of the fisheye image, intersection points are projected onto a hemisphere as is and non-intersection points are interpolated, and a further transformation into a perspective projection image is performed. An equirectangular image is obtained by an equirectangular transformation of the fisheye image; the transformation is performed in a form in which, similarly to the mesh, lens distortion has been removed, and a transformation into a perspective projection image is performed at the time of HMD display. For fisheye images and equirectangular images, a wide-angle region can also be recorded in an image as two-dimensional image data, but a portion having a large image height (a wide-angle region) ends up being recorded greatly distorted with respect to the central portion.

In a case of applying image processing to a non-perspective projection image, such as a fisheye image, on the assumption that the image will be viewed in an HMD, a technique in the specification of US-2020-0382755 requires changing the image processing in accordance with the projection method and the field of view in order to achieve a uniform image processing result for all field of views.

### SUMMARY

One aspect of the embodiments provides a technique for enabling image processing for perspective projection to be applied to non-perspective projection images independently of the region in the image.

According to the first aspect of the present disclosure, there is provided an image processing apparatus that comprises one or more memories and one or more processors. The one or more processors and the one or more memories are configured to input a non-perspective projection image; transform a respective image in each image region of a plurality of image regions in the non-perspective projection image into a respective perspective projection image; and, for each of the respective perspective projection images, after applying image processing to the respective perspective projection image, transform the result of the image processing into a respective non-perspective projection image.

According to the second aspect of the present disclosure, there is provided a method of image processing performed by an image processing apparatus, the method comprising inputting a non-perspective projection image; transforming a respective image in each image region of a plurality of image regions in the non-perspective projection image into a respective perspective projection image; and, for each of the respective perspective projection images, after applying image processing to the respective perspective projection image, transforming the result of the image processing into a respective non-perspective projection image.

According to the third aspect of the present disclosure, there is provided a non-transitory computer-readable storage medium storing computer-executable instructions for causing a computer to input a non-perspective projection image; transform a respective image in each image region of a plurality of image regions in the non-perspective projection image into a respective perspective projection image, and, for each of the respective perspective projection images, after applying image processing to the respective perspective projection image, transform the result of the image processing into a respective non-perspective projection image.

Further features of various embodiments of the present disclosure will become apparent from the following description of exemplary embodiments with reference to the attached drawings.

### BRIEF DESCRIPTION OF THE DRAWINGS

FIG. 1 is a block diagram illustrating an example of a hardware configuration of an image processing apparatus.

FIG. 2 is a flowchart of processing performed by the image processing apparatus.

FIG. 3 is a diagram illustrating a relationship between a division region and a perspective projection image corresponding to the division region.

FIG. 4 is a flowchart of processing performed by the image processing apparatus.

FIG. 5 is a diagram illustrating a configuration example of an alpha channel map.

FIG. 6 is a flowchart of processing performed by the image processing apparatus.

FIG. 7 is a flowchart of processing performed by the image processing apparatus.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but limitation is not made to embodiments that require all such features, and multiple such features may be combined as appropriate. Furthermore, in the attached drawings, the same reference numerals are given to the same or similar configurations, and redundant description thereof is omitted.

### First Embodiment

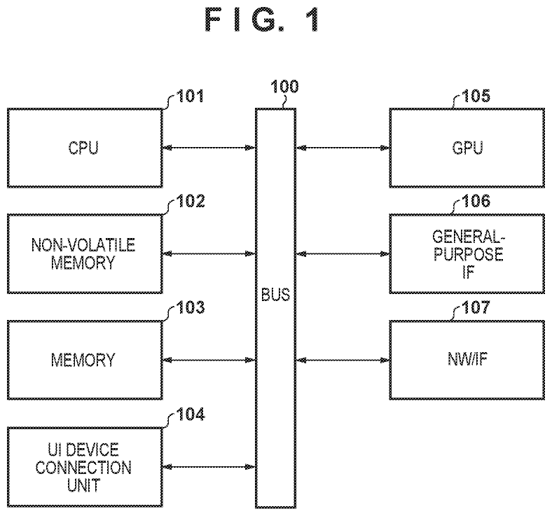

First, a hardware configuration example of the image processing apparatus according to the present embodiment will be described with reference to a block diagram of FIG. 1. A Central Processing Unit (CPU) 101 executes various processes using computer programs and data stored in a memory 103. Thus, the CPU 101 controls the operation of the entire image processing apparatus and executes or controls various processes described as processes performed by the image processing apparatus.

A non-volatile memory 102 stores an operating system (OS), computer programs, and data for causing the CPU 101 or a GPU 105 to execute or control various processes described as processes performed by the image processing apparatus, and the like. Computer programs and data stored in the non-volatile memory 102 are loaded into the memory 103 as appropriate under the control of the CPU 101, and are processed by the CPU 101 or the GPU 105.

The memory 103 has an area for storing computer programs and data loaded from the non-volatile memory 102. In addition, the memory 103 has an area for storing data received from the outside via a general-purpose interface (IF) 106 or a network interface (NW/IF) 107. The memory 103 has a work area used when the CPU 101 or the GPU 105 executes various processes. As described above, the memory 103 can provide various areas as appropriate.

A UI device connection unit 104 is an interface for connecting a user interface, such as a keyboard, a mouse, or a touch panel. Various instructions inputted by the user by operating the user interface are notified to the CPU 101 via the UI device connection unit 104.

The GPU 105 performs various types of image processing under the control of the CPU 101. The general-purpose IF 106 is an interface for performing data communication with a device, such as a device to which an image generated by the image processing apparatus is to be outputted (for example, a device accessible by an HMD), a device capable of supplying an image to the image processing apparatus (for example, an image capturing apparatus or a memory apparatus), or the like.

The NW/IF 107 is an interface for performing data communication with an external device via a wired and/or wireless network, such as a LAN or the Internet. Note that the image processing apparatus may perform data communication with a device, such as a device that is an output destination of an image generated by the image processing apparatus and a device that can supply an image to the image processing apparatus, via the NW/IF 107.

The CPU 101, the non-volatile memory 102, the memory 103, the UI device connection unit 104, the GPU 105, and the general-purpose IF 106, the NW/IF 107 are all connected to a bus 100.

For example, a computer apparatus, such as a personal computer (PC), a smart phone, or a tablet terminal apparatus, can be applied to such an image processing apparatus. Further, hardware configurations applicable to the image processing apparatus according to the present embodiment are not limited to the configuration illustrated in FIG. 1, and can be modified/changed as appropriate.

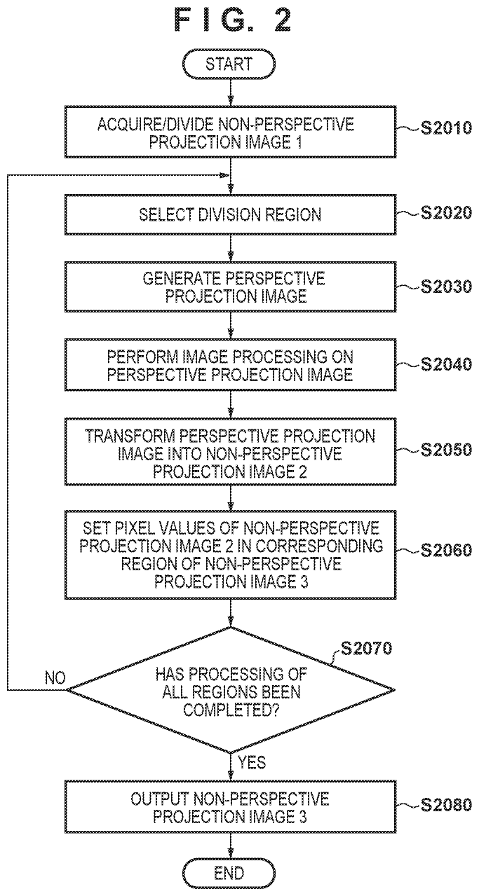

Next, the processing performed by the image processing apparatus will be described in accordance with the flowchart of FIG. 2. In step S2010, the CPU 101 acquires a non-perspective projection image 1, which is an image of an equirectangular projection, into the memory 103. The method of acquiring the non-perspective projection image 1 is not limited to a particular acquisition method.

For example, the CPU 101 may load the non-perspective projection image 1 stored in the non-volatile memory 102 into the memory 103. The CPU 101 may receive a captured image (non-perspective projection image 1) captured by an image capturing apparatus via the general-purpose IF 106 or the NW/IF 107 and store the received image in the memory 103. The captured image that is captured by the image capturing apparatus may be an image of a respective frame in a moving image captured by the image capturing apparatus, or may be a still image captured periodically or irregularly by the image capturing apparatus. The CPU 101 may receive a non-perspective projection image 1 stored in an external device, such as a cloud server, via the NW/IF 107 and store the received image in the memory 103.

In the following, for the purpose of concrete explanation, an example will be described for a case in which the non-perspective projection image 1 is an image (equirectangular image) of an equirectangular projection in which the size in the vertical direction is 1750 pixels, the angle in the vertical direction is 175 degrees, the size in the horizontal direction is 1800 pixels, the angle in the horizontal direction is 180 degrees, and the pixel values of the respective pixels are floating point RGB values.

Then, the CPU 101 divides the acquired non-perspective projection image 1 into a plurality of division regions. In the following, to give a concrete explanation, an example of a case where the division regions are rectangular regions having a size of 25 pixel×25 pixels will be described.

In step S2020, the CPU 101 selects one of the plurality of division regions divided in step S2010 that has not been selected as the selected division region. The selection order of the division regions is not limited to a specific selection order, and, for example, the division regions in the non-perspective projection image 1 may be sequentially selected from the upper left to the right and from the top to the bottom.

In step S2030, the CPU 101 sets, as an extended selected division region, an image region of 33 pixels×33 pixels in which a frame having a width of 4 pixels is added to the selected division region on the top, bottom, left, and right, and transforms an image in the extended selected division region (in the image region) in the non-perspective projection image 1 into a perspective projection image. The pixel position of the center in the non-perspective projection image 1 is set as the origin, the pixel position of the pixel of interest in the extended selected division region is set as (x_{equi}, y_{equi}), and the pixel position of the pixel in the center of the extended selected division region is set as (x_{equi_c}, y_{equi_c}). Here, λ=x_{equi}/10, θ=y_{equi}/10, λc=x_{equi_c}/10, θc=y_{equi_c}/10, and s=12.5/tan(12.5). In this case, the pixel position (x, y) of the pixel on the perspective projection image corresponding to the pixel of interest can be obtained according to the following Equation (1).

$$( \begin{matrix}x \\ y\end{matrix} ) = s ( \begin{matrix}tan λ - {λ}_{c} \\ \frac{tan θ - {θ}_{c}}{cos λ - {λ}_{c}}\end{matrix} ) \qquad ( 1 )$$

Equation (1) is an expression representing a transformation from the coordinate system of the equirectangular image to the coordinate system of the perspective projection image. The trigonometric function calculates in degrees. The CPU 101 obtains the pixel position of the pixel corresponding to the respective pixel of interest in the extended selected division region based on Equation (1), and sets the pixel value of the pixel of interest to the pixel value of the corresponding pixel. The pixel values of the pixels other than the corresponding pixels in the perspective projection image are obtained by, for example, interpolation using the pixel values of the corresponding pixels in the vicinity.

In the present embodiment, s is set so that the enlargement ratio of the central portion of the extended selected division region is approximately 100%. The reason for adding a frame having a width of 4 pixels to the selected division region is to refer to the outside of the region when applying a 9×9 Gaussian filter in the next step.

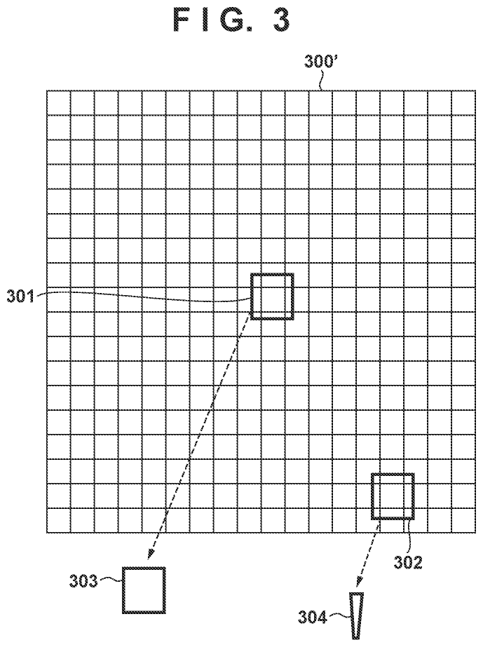

Here, the relationship between the division region and the perspective projection image corresponding to the division region will be described with reference to FIG. 3. In FIG. 3, reference numeral 300 denotes a group of partial division regions in the non-perspective projection image 1. An extended selection division region 301 is an image region of 33 pixels×33 pixels obtained by adding a frame having a width of 4 pixels on the top, bottom, left, and right of a division region of 25 pixels×25 pixels, and is transformed into a perspective projection image 303 by transformation according to the position of the division region in the non-perspective projection image 1. An extended selection division region 302 is an image region of 33 pixels×33 pixels obtained by adding a frame having a width of 4 pixels on the top, bottom, left, and right of a division region of 25 pixels×25 pixels, and is transformed into a perspective projection image 304 by transformation according to the position of the division region in the non-perspective projection image 1. As described above, by performing the transformation based on the parameter corresponding to the pixel position of the pixel in the division region, the image is transformed (projected) into a perspective projection image having a different shape according to the position of the division region.

In step S2040, the CPU 101 performs filter processing on the perspective projection image generated in step S2030 using a bilateral filter as an example of image processing.

In step S2050, the CPU 101 generates, as a non-perspective projection image 2, an image of 25 pixels×25 pixels obtained by omitting the frame having a width of 4 pixels on the top, bottom, left, and right from a non-perspective projection image of 33 pixels×33 pixels obtained by performing, on the perspective projection image subjected to the image processing in step S2040, an inverse transformation to the transformation (the transformation according to the Equation (1)) performed in step S2030.

In step S2060, the CPU 101 specifies, in a non-perspective projection image 3 having the same size as the non-perspective projection image 1 (the number of pixels in the vertical direction and the number of pixels in the horizontal direction are the same), a corresponding region which corresponds to the selected division region selected in step S2020, and sets, to each pixel in the corresponding region, the pixel value corresponding to that pixel in the non-perspective projection image 2. As a result, a non-perspective projection image 3 in which the non-perspective projection image 2 is arranged at the position in the same arrangement order as the arrangement order of the selected division region is obtained.

In step S2070, the CPU 101 determines whether or not all division regions have been selected as the selected division region. In a case where the result of the determination is that all the division regions have been selected as the selected division region, the process proceeds to step S2080. On the other hand, in a case where there remains a division region that has not yet been selected as the selected division region, the process proceeds to step S2020.

In step S2080, the CPU 101 outputs a non-perspective projection image 3 (a combined image of non-perspective projection images 2 arranged in the above-described step S2060). A non-perspective projection image 2 corresponding to the Pth (P is an integer of 1 or more) division region from the left end in the division region group in the non-perspective projection image 1 and the Qth (Q is an integer of 1 or more) division region from the upper end is arranged at position P from the left end and Q from the upper end in the group of non-perspective projection images 2 in the non-perspective projection image 3. When such a combined image is outputted as an image to be displayed on the HMD, the combined image is an image close to what can be seen from the HMD.

The output destination of the non-perspective projection image 3 is not limited to a particular output destination, and the CPU 101 may transmit the non-perspective projection image 3 to an external device, such as a mobile terminal apparatus, a server device, or the like, held by the user via the general-purpose IF 106 or the NW/IF 107. In addition, the CPU 101 may store the non-perspective projection image 3 in the non-volatile memory 102.

Even in a live shot, a part of a wide-angle image using a fisheye lens is cut out following the movement of the head, and is transformed into a perspective projection image for display. In the case of the transformation from the equirectangular image to the perspective projection image, in the region where the image height above and below the center region is large, a transformation for reduction in the lateral direction is performed. In other words, in a case where filter processing is performed on the equirectangular transformed image, the result of image processing applied to the equirectangular image changes depending on the position of the upper and lower image height in the case of subsequent transformation into a perspective projection image. According to the present embodiment, the image processing is performed by transforming each division region into a perspective projection image, and then once again projecting and combining the images, whereby, for example, even when the images are displayed in an HMD, the image processing effect can be achieved regardless of the image height. In particular, in the bilateral filter, the sharpness of pixels (of an edge) of an input image is analyzed and an amount of an effect is changed. Therefore, it is possible to more accurately achieve the desired result of the image processing at the time of viewing by processing the perspective projection image using the present technique, rather than direct application to an equirectangular image that is more stretched the larger the vertical image height is.

This processing is synonymous with image processing in which a part of a spherical surface that has been sufficiently finely divided is regarded as a perspective projection image in a case where an equirectangular image is projected onto a spherical surface. It should be noted that a similar effect to that of the present technique can be achieved by changing the size and shape of a filter kernel for each pixel. However, there is a disadvantage in that the calculation amount for calculating the filter kernel is increased for each pixel, and that the calculation amount is further increased since the filter size becomes larger in locations where the upper and lower image heights are large, and thus the utility of the present technique is high.

In the present embodiment, a case has been described in which a filter process using a bilateral filter is performed as image processing on a perspective projection image, but other types of image processing may be used. For example, the image processing may be a band-pass filter, such as a low-pass filter, or sharpening processing (super resolution processing) using deep learning, or the like. Since the sharpening processing using deep learning is also image processing performed on the basis of analysis results (characteristics) of the input image, the effect of the sharpening in this processing is high.

Further, in the present embodiment, a case has been described in which the non-perspective projection image 1 is an equirectangular image, but the present embodiment is not limited thereto, and any projection image may be used as long as it can record a wide-angle region that cannot be recorded with a perspective projection image. When an image of a wide-angle region is recorded as a two-dimensional image, the image of the wide-angle region is distorted and recorded, and so the effect of the present technique can be sufficiently achieved.

Further, in the present embodiment, a case has been described in which the non-perspective projection image 2 is an equirectangular image, but there is not limitation thereto, and any projection image that can record a wide-angle region of an input image may be used, and there is no dependency on the input image. Therefore, there may be a transformation from the fisheye image to a fisheye image, a transformation from a fisheye image to an equirectangular image, a transformation from an equirectangular image to an equirectangular image, and a transformation from an equirectangular image to a fisheye image, respectively. Further, when the input image is a fisheye image, it may be desirable to remove lens distortion and then do the transformation. This means that the coordinates of the corresponding pixels will not coincide with each other even in the transformation from the fisheye image to the fisheye image.

Further, in the present embodiment, a case has been described in which the non-perspective projection image 1 is divided into 70 divisions in the vertical direction and 72 divisions in the horizontal direction, but the present embodiment is not limited thereto. By reducing the number of divisions, it is also possible to realize high-speed processing with reduced processing overhead. Therefore, the user may designate the number of divisions and the accuracy (converted into the number of divisions internally) through a UI. In addition, the user may make an instruction by selecting from a plurality of image processes prepared in advance, and the CPU 101 may perform the instructed image process.

Further, the transformation to the perspective projection image in the present embodiment has been described as projecting one pixel at a time. However, for example, the result of transforming the pixel positions of the four corners of the division region as described above may be set as the pixel positions of the four corners of the perspective projection image, and the pixel values of the pixels of the four corners of the division region may be set as the pixel values of the four corners of the perspective projection image. The other pixels in the perspective projection image may be calculated by linear interpolation from the pixel values of the four corners of the perspective projection image. In the present embodiment, since there is sufficiently fine division into 70 and 72 vertical and horizontal divisions, respectively, the error is small even when linear interpolation is performed.

The non-perspective projection image 1 may be a monocular fisheye image, a stereoscopic fisheye image, or a 360-degree equirectangular image transformed from two or more fisheye images. The expression “perspective projection” in the present embodiment indicates a projection method in which all points on a three-dimensional object are radially focused on a single viewpoint, and is not limited to a strict perspective projection. So long as the points are focused on a single viewpoint, there may be transformation into images having different aspect ratios or transformation approximating that. There may also be transformation in which the vertical coordinates converge to a horizontal line, or transformation in which the horizontal coordinates converge to a vertical direction. For example, by applying a vertical one-dimensional filter and a horizontal one-dimensional filter to each transformation image, it is possible to achieve an effect equivalent to applying a one-dimensional filter to the perspective projection image.

### Second Embodiment

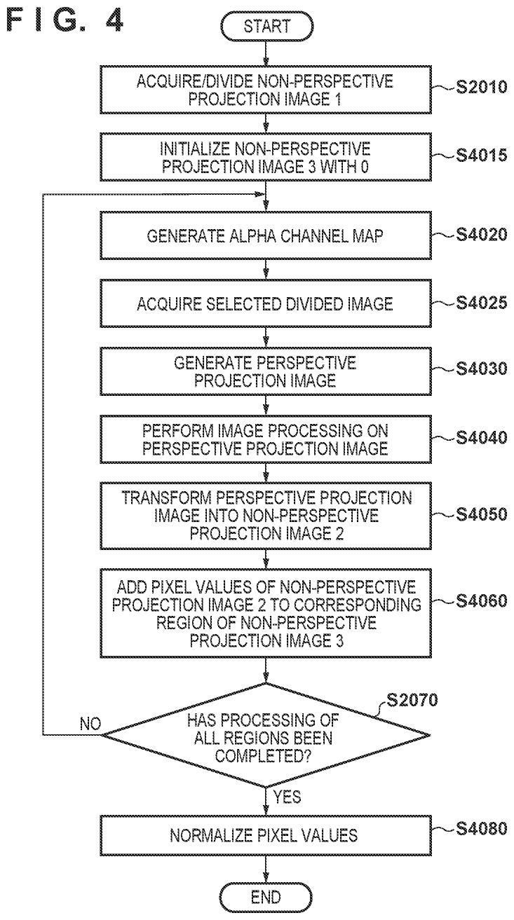

In this and subsequent embodiments, differences from the first embodiment will be described, and the embodiment is assumed to be similar to the first embodiment unless otherwise mentioned specifically below. The processing performed by the image processing apparatus according to the present embodiment will be described in accordance with the flowchart of FIG. 4. In FIG. 4, similar processing steps to those illustrated in FIG. 2 are denoted by the same step numbers, and description of such processing steps will be omitted or described simply.

In step S4015, the CPU 101 generates a non-perspective projection image 3 having the same size as the non-perspective projection image 1 (the number of pixels in the vertical direction and the number of pixels in the horizontal direction are the same), and the CPU 101 initializes the pixel value (RGB value and alpha channel value) of each pixel of the non-perspective projection image 3 to 0.

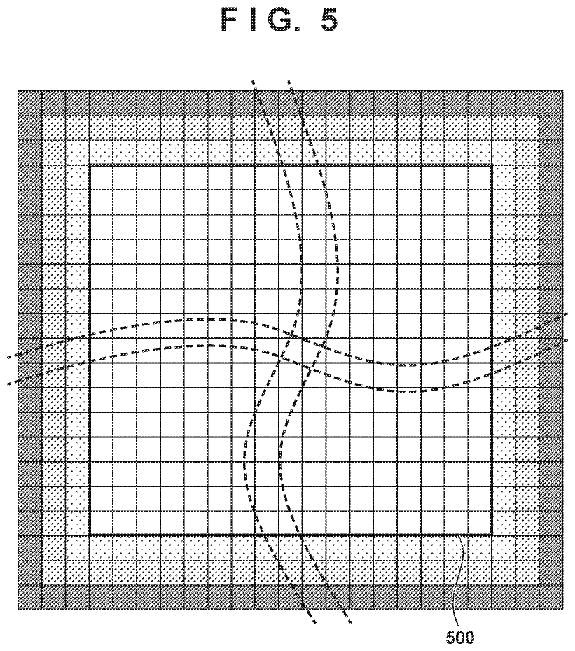

In step S4020, the CPU 101 selects one of the plurality of division regions divided in step S2010 that has not been selected as the selected division region, and sets a frame with a 3-pixel width as a blend region in the vicinity of the selected division region. Then, the CPU 101 generates an alpha channel map in which an image region composed of a selected division region and a blend region is defined as the extended selected division region, and a blend ratio of each pixel belonging to the extended selected division region is registered. The alpha channel map will be described with reference to FIG. 5.

As illustrated in FIG. 5, in the present embodiment, the CPU 101 sets, as a blend region, a frame having a width of three pixels around a selected division region 500 having a size of 25 pixel×25 pixels. The CPU 101 then generates an Alpha Channel Map with the following registrations: “1” as the blend ratio of each of the elements belonging to the selected division region 500, “0.75” as the blend ratio of pixels that are 1 pixel to the outside of the selected division region 500, “0.5” as the blend ratio of the pixels that are 2 pixels to the outside of the selected division region 500, and “0.25” as the blend ratio of the pixels that are 3 pixels to the outside of the selected division region 500.

In step S4025, the CPU 101 obtains an image in the extended selected division region as a selected divided image. That is, each selected divided image acquired in step S4025 has a property that adjacent selected divided images have overlapping portions. In the present embodiment, the following processes may be performed in step S4020 and step S4025.

Specifically, in the first time through step S4020, the CPU 101 arranges a rectangular window of size 31 pixels×31 pixels at the position in the upper left corner of the non-perspective projection image 1, and generates an alpha channel map of the image of the image region in the arranged rectangular window. Then, in the first time through step S4025, the CPU 101 acquires the image of the image region in the arranged rectangular window as the selected divided image.

In the second time through step S4020, the CPU 101 moves the previously placed rectangular window 25 pixels to the right to generate an alpha channel map of the image of the image region in the moved rectangular window. Then, in the second time through step S4025, the CPU 101 acquires the image of the image region in the arranged rectangular window as the selected divided image.

In the {72×N (N is an integer greater than or equal to 1)+1}th time through step S4020, the CPU 101 moves the rectangular window arranged in the (72×N)th time through step S4020 downward by 25 pixels and moves it to the left end of the non-perspective projection image 1. Then, in the {72×N (N is an integer greater than or equal to 1)+1}th time through step S4020, the CPU 101 generates an alpha channel map of the image of the image region in the moved rectangular window. Then, in the {72×N (N is an integer greater than or equal to 1)+1}th time through step S4025, the CPU 101 acquires the image of the image region in the arranged rectangular window as the selected divided image.

Then, the CPU 101 obtains s; s is a parameter used in the above Equation (1), and is assumed to be calculated according to the deformation amount at the time of projection from the non-perspective projection image to the perspective projection image, where s is obtained according to the following Equations (2) and (3).

$$( \begin{matrix}dx \\ dy\end{matrix} ) = ( \begin{matrix}\vert tan ( {λ}_{c} - 0.5 ) - tan ( {λ}_{c} + 0.5 ) \vert \\ \vert \frac{tan ( {θ}_{c} - 0.5 )}{cos ( {λ}_{c} - 0.5 )} - \frac{tan ( {θ}_{c} + 0.5 )}{cos ( {λ}_{c} + 0.5 )} \vert\end{matrix} ) \qquad ( 2 )$$

$$s = min ( \sqrt{{dx}^{2} + {dx}^{2}} , 1 ) \qquad ( 3 )$$

In step S4030, the CPU 101 transforms the selected divided image into a perspective projection image according to Equation (1) in the same manner as in the first embodiment. In step S4040, the CPU 101 performs “a convolution integration with a 9×9 Gaussian filter kernel”, which is an example of image processing, on the perspective projection image generated in step S4030.

In step S4050, the CPU 101 performs, on the perspective projection image on which the image processing was performed in step S4040, an inverse transformation (the transformation according to the Equation (1)) to the transformation performed in step S4030, to thereby perform the transformation into the non-perspective projection image 2.

In step S4060, the CPU 101 identifies a corresponding region that corresponds to the extended selected division region in the non-perspective projection image 3, and adds, to each pixel value in the corresponding region, the pixel value that corresponds to that pixel in the non-perspective projection image 2 generated in step S4050. In the addition of pixel values, addition of RGB values and addition of alpha channel values are performed.

In step S2070, the CPU 101 determines whether or not all the division regions have been selected as the selected division region. In a case where the result of the determination is that all the division regions have been selected as the selected division region, the process proceeds to step S4080. On the other hand, in a case where there remains a division region that has not yet been selected as the selected division region, the process proceeds to step S4020.

In step S4080, the CPU 101 obtains a quotient value obtained by dividing an RGB value of each pixel in the non-perspective projection image 3 by the value of the alpha channel of the pixel, and updates (normalizes) the pixel value of the pixel to the quotient value.

Depending on the image processing method, the boundary may become clear when the perspective projection image is transformed into the non-perspective projection image 2 and recombined. According to the present embodiment, it is possible to make the boundary less conspicuous by providing and blending overlapping regions at the time of combining. Further, by changing the strength of the blend in accordance with the amount of deformation when projecting from the non-perspective projection image to the perspective projection image, it is possible to suppress deterioration of the image quality due to the blending process.

### Third Embodiment

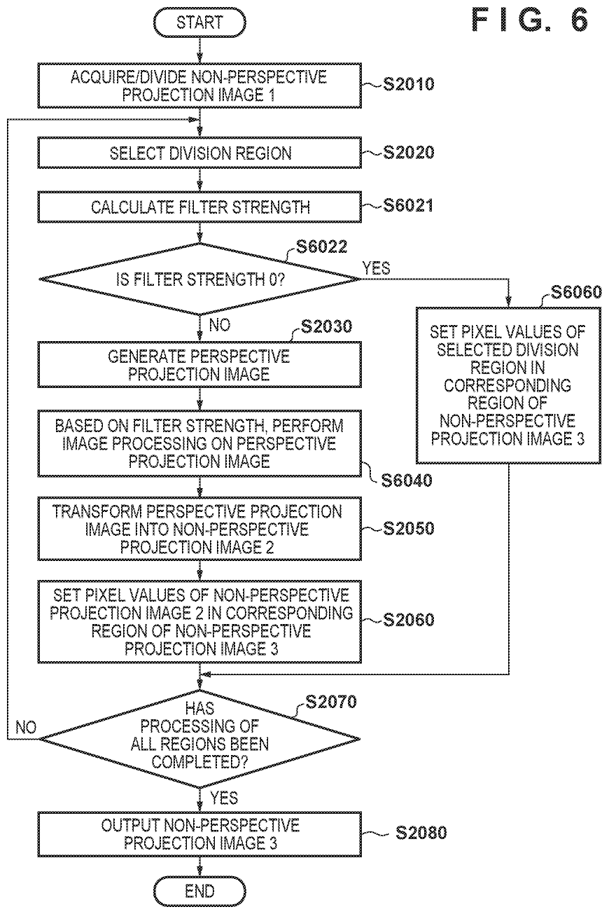

The processing performed by the image processing apparatus according to the present embodiment will be described in accordance with the flowchart of FIG. 6. In FIG. 6, similar processing steps to those illustrated in FIG. 2 are denoted by the same processing step numbers, and description of such processing steps will be omitted or described simply. In step S6021, the CPU 101 obtains a filter strength σ corresponding to the selected division regions according to the following Equations (4) to (6).

$${s}_{x} = \{ \begin{matrix}\frac{- {λ}_{c} - 50}{50} & {λ}_{c} < - 50 \\ 0 & - 50 \leq {λ}_{c} \leq 50 \\ \frac{{λ}_{c} - 50}{50} & {λ}_{c} > 50\end{matrix} \qquad ( 4 )$$

$${s}_{y} = \{ \begin{matrix}\frac{- {θ}_{c} - 35}{50} & {θ}_{c} < - 35 \\ 0 & - 35 < {θ}_{c} < 50 \\ \frac{{θ}_{c} - 35}{50} & {θ}_{c} > 50\end{matrix} \qquad ( 5 )$$

$$σ = \sqrt{{s}_{x}^{2} + {s}_{y}^{2}} \qquad ( 6 )$$

In step S6022, the CPU 101 determines whether or not the filter strength σ is equal to or less than the threshold &, and if the filter strength σ is equal to or less than the threshold, the process proceeds to step S6060, and if the filter strength σ is greater than the threshold, the process proceeds to step S2030. In the present embodiment, the CPU 101 determines whether or not the filter strength σ is 0. If the result of the determination is that the filter strength σ is 0, the process proceeds to step S6060, and if the filter strength σ is not 0, the process proceeds to step S2030.

In step S6040, the CPU 101 performs filter processing on the perspective projection image generated in step S2030 applying a 9×9 Gaussian filter with the filter strength σ obtained in step S6021, as an example of image processing.

In step S6060, in a non-perspective projection image 3 having the same size as the non-perspective projection image 1 (the number of pixels in the vertical direction and the number of pixels in the horizontal direction are the same), the CPU 101 specifies a corresponding region corresponding to the selected division region selected in step S2020, and sets, to each pixel value in the corresponding region, the pixel value corresponding to that pixel in the selected division region.

As described above, according to the present embodiment, it is possible to change the strength of the filter according to the position from the center of the image while reducing calculation load, such as that for calculating the filter kernel for each pixel. In the present embodiment, it is only necessary to apply the filter processing to the perspective projection image by changing the filter strength σ as the strength, and it is not necessary to perform complicated processing, such as changing the aspect ratio of the shape of the kernel for each position of the selected division region. In VR images, the center tends to be focused on, and the degree to which a region is focused on decreases as the image height increases. In addition, the field of view is smaller at the upper and lower sides than at the left and right sides. By blurring a region that tends not to be focused on, the encoding amount when encoding an image can be effectively reduced in accordance with visual sensitivity at the time of viewing. In the present embodiment, since the amount of deformation is small in a region where the upper and lower image heights are small, image processing is performed in the original projection space without performing the perspective projection transformation, and the images are combined.

### Fourth Embodiment

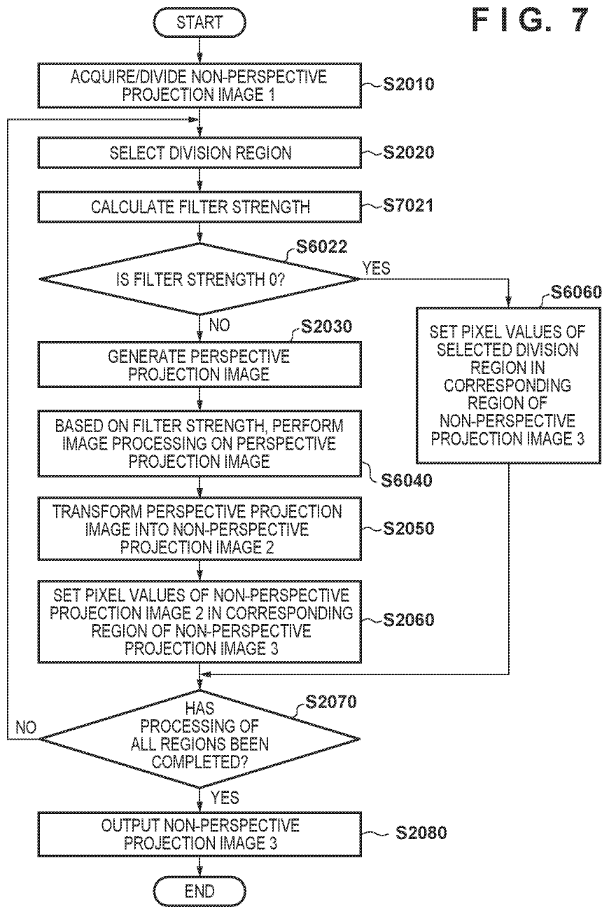

The processing performed by the image processing apparatus according to the present embodiment will be described in accordance with the flowchart of FIG. 7. In FIG. 7, similar processing steps to those illustrated in FIGS. 2 and 6 are denoted by the same processing step numbers, and description of such processing steps will be omitted or described simply.

In step S7021, the CPU 101 obtains the filter strength σ corresponding to the selected division region according to the following Equations (7) to (9) (the filter strength σ is calculated based on the amount of deformation due to projection of the position of the selected division region).

$$( \begin{matrix}dx \\ dy\end{matrix} ) = ( \begin{matrix}\vert tan ( {λ}_{c} - 0.5 ) - tan ( {λ}_{c} + 0.5 \vert \\ \vert \frac{tan ( {θ}_{c} - 0.5 )}{cos ( {λ}_{c} - 0.5 )} - \frac{tan ( {θ}_{c} + 0.5 )}{cos ( {λ}_{c} + 0.5 )} \vert\end{matrix} ) \qquad ( 7 )$$

$${σ}_{0} = \sqrt{{dx}^{2} + {dy}^{2}} \qquad ( 8 )$$

$$σ = \{ \begin{matrix}{σ}_{0} & {σ}_{0} > 0.3 \\ 0 & otherwise\end{matrix} \qquad ( 9 )$$

As described above, according to the present embodiment, it is possible to change the filter strength in accordance with the deformation amount at the time of projection while reducing the calculation load, such as that for calculating the filter kernel for each pixel. In the present embodiment, it is only necessary to change the filter strength σ and apply filter processing to the perspective projection image, and complicated processing, such as changing the aspect ratio of the shape of the kernel for each position of the selected division region, is not necessary.

In transforming an equirectangular image into a perspective projection image during HMD viewing, an image at a position where the image height is higher is deformed to be laterally reduced, and a folding deformation is likely to occur. In the present embodiment, by applying a stronger low-pass filter as the deformation amount of a region is larger, folding deformation can be suppressed.

### Fifth Embodiment

The non-perspective projection image 3 may be incorporated as part of a UI function as needed and outputted to a device or file. As described above, various modifications to what kind of data the non-perspective projection image 3 is to be transmitted with and in what form the non-perspective projection image 3 is to be transmitted can be considered, and the present embodiment is not limited to specific modifications.

Not all steps in the process according to the above flowcharts are necessarily performed in the illustrated order. That is, the execution order of some of the processing steps may be changed, or some of the processing steps may be executed in parallel with other processing steps.

Further, in the above explanation, a case has been described in which the CPU 101 performs all of the processing according to the flowchart, but a part of the processing may be executed by the GPU 105. For example, some or all of the processing related to images, such as image division, transformation, and image processing, may be executed by the GPU 105 under the control of the CPU 101.

Further, the processing according to the above-described flowchart may be executed in real time on the image of each of frames which are inputted sequentially, or may be executed in non-real time on the image of each of frames stored in the memory device. The non-perspective projection image 3 obtained as a result of the processing may be output/transmitted in real time, or may be output/transmitted in non-real time.

Further, in the above embodiment, a case has been described in which the non-perspective projection image 1 is an image of an equirectangular projection (equirectangular image), but some embodiments are not limited thereto, and for example, the non-perspective projection image 1 may be a fisheye image. When the non-perspective projection image 1 is not an equirectangular image, the shape of the division region may be non-rectangular. Further, “division of a region” may be achieved by separating an image into a plurality of division regions, or may be achieved by dividing an image into a plurality of division regions such that adjacent division regions have portions that overlap with each other, and the division method is not limited to a particular division method.

Further, the numerical values, processing timings, processing orders, performers of the processing, acquisition methods/transmission destinations/transmission sources/storage locations of data (information), and the like used in the above-described embodiments are given as examples for the purpose of concrete explanation, and there is no intention to be limited to such examples.

In addition, some or all of the above-described embodiments may be appropriately combined and used. In addition, some or all of the above-described embodiments may be used selectively.

### OTHER EMBODIMENTS

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2023-023632, which was filed on Feb. 17, 2023 and which is hereby incorporated by reference herein in its entirety.

What is claimed is:

1. An image processing apparatus, comprising:
one or more memories; and
one or more processors, wherein the one or more processors and the one or more memories are configured to:
input a non-perspective projection image;
transform a respective image in each image region of a plurality of image regions in the non-perspective projection image into a respective perspective projection image; and
for each of the respective perspective projection images, after applying image processing to the respective perspective projection image, transform the result of the image processing into a respective non-perspective projection image.

2. The image processing apparatus according to claim 1, wherein the one or more processors and the one or more memories are further configured to transform the respective image in each image region of the plurality of image regions into the respective perspective projection image based on a parameter corresponding to a pixel position of a pixel in the image region and an angle of a vertical direction and a horizontal direction of the image region.

3. The image processing apparatus according to claim 1, wherein the one or more processors and the one or more memories are further configured to apply a bilateral filter to the respective perspective projection images.

4. The image processing apparatus according to claim 1, wherein the one or more processors and the one or more memories are further configured to apply a band-pass filter to the respective perspective projection images.

5. The image processing apparatus according to claim 1, wherein the one or more processors and the one or more memories are further configured to perform sharpening processing, for which deep learning is used, on the respective perspective projection images.

6. The image processing apparatus according to claim 1, wherein the one or more processors and the one or more memories are further configured to perform a convolution integration by a Gaussian filter kernel on the respective perspective projection images.

7. The image processing apparatus according to claim 1, wherein the one or more processors and the one or more memories are further configured to:
transform the respective image in each image region of the plurality of image regions, which have overlapping portions with adjacent image regions, into the respective perspective projection image, apply image processing to the respective perspective projection image, and transforms the result into the respective non-perspective projection image;
generate a combined image based on the respective non-perspective projection images; and
based on a blend ratio corresponding to each pixel of the combined image, normalize a pixel value of the pixel.

8. The image processing apparatus according to claim 1, wherein the one or more processors and the one or more memories are further configured to perform filter processing, with a filter strength corresponding to the respective image region in the non-perspective projection image, on the respective perspective projection image corresponding to that image region, and then transform the result into the respective non-perspective projection image.

9. The image processing apparatus according to claim 8, wherein the one or more processors and the one or more memories are further configured to obtain a filter strength based on a position of the respective image region in the non-perspective projection image.

10. The image processing apparatus according to claim 8, wherein the one or more processors and the one or more memories are further configured to obtain a filter strength based on an amount of deformation due to projection of a position of at least one of the plurality of image regions in the non-perspective projection image.

11. The image processing apparatus according to claim 1, wherein the one or more processors and the one or more memories are further configured to:
generate a combined image based on the respective non-perspective projection images for the plurality of image regions, and
output the combined image.

12. The image processing apparatus according to claim 11, wherein the one or more processors and the one or more memories are further configured to output the combined image as an image for display on a head-mounted display.

13. The image processing apparatus according to claim 1, wherein the image processing is selected by an instruction by a user from among a plurality of image processes defined in advance.

14. A method of image processing performed by an image processing apparatus, the method comprising:
inputting a non-perspective projection image;
transforming a respective image in each image region of a plurality of image regions in the non-perspective projection image into a respective perspective projection image; and
for each of the respective perspective projection images, after applying image processing to the respective perspective projection image, transforming the result of the image processing into a respective non-perspective projection image.

15. A non-transitory computer-readable storage medium storing computer-executable instructions for causing a computer to
input a non-perspective projection image;
transform a respective image in each image region of a plurality of image regions in the non-perspective projection image into a respective perspective projection image; and
for each of the respective perspective projection images, after applying image processing to the respective perspective projection image, transform the result of the image processing into a respective non-perspective projection image.
